(19) United States
(12) Patent Application Publication
(10) Pub. No.: US 2020/0096076 A1
(43) Pub. Date: Mar. 26, 2020

(54) ENERGY ABSORBER

(71) Applicant: SafeSeat lP AB, Stockholm (SE)

(72) Inventors: Ingvar Eriksson, Stockholm (SE); Dag Linderholm, Rönninge (SE); Stefan Svensson, Bergshamra (SE); Magnus Eneström, Enebyberg (SE)

(21) Appl. No.: 15/743,087

(22) PCT Filed: Jun. 23, 2016
(86) PCT No.: PCT/EP2016/064523

§ 371 Date: Jan. 9, 2018

(30) Foreign Application Priority Data
Jul. 10, 2015 (SE) 1551002-7

(51) Int. Cl. F16F 15/03; F16F 7/12; B60N 2/427; F16F 7/02; F16F 9/02; F16F 15/04

(52) U.S. Cl. CPC F16F 15/03; F16F 7/12; F16F 15/04; F16F 7/023; F16F 9/0245; B60N 2/42727

(57) ABSTRACT

An energy absorber having a bar movable along a longitudinal axis by a tensile force. First and second energy absorbers extend along the longitudinal axis. A coupling mechanism couples the second energy absorber to the bar. The first energy absorber activates upon movement of the bar along the longitudinal axis. The coupling mechanism has a force transferring element to transfer force from the bar to the second energy absorber upon activation by a trigger. The trigger is subjected to a trigger load that is proportional to the bar's velocity along the longitudinal axis. The trigger is displaceable from its unloaded position upon loading and, simultaneously, constrained from displacing by a constraining force acting in opposite direction of the trigger load. The trigger displaces to activate the force transferring element to activate the second energy absorber when the velocity of the bar is above first pre-determined non-zero amount.

This application is a U.S. National Phase application of PCT International Application No. PCT/EP2016/064523, filed Jun. 23, 2016, which claims the benefit of Swedish Application 1551002-7, filed Jul. 10, 2015, both of which are incorporated by reference herein.

### TECHNICAL FIELD

The present invention relates to a mechanism for energy absorption, and particularly to an energy absorber.

### BACKGROUND

In many situations, it is desirable to introduce damping functions, such as provided by an energy absorber, in a mechanical structure in order to reduce forces generated during collisions and impacts.

A common cause of whiplash injury is in air crashes when a motorist is hit from behind. A motorist will hereinafter be called the seat occupant. An example is an overtaking vehicle colliding with the vehicle in front. Another example is frontal collision where the seat occupant is pressed against an expanding air bag. A further example is frontal collusion where a child is sitting in a chair facing away from the car's direction of travel. Another example where it may be desirable to use energy absorbing mechanisms is thus in car seats. At the collision, an energy absorbing mechanism may be used to absorb energy such that the forces on the seat occupant of the car reduce during the collision.

Another example where energy absorbers are used is in crash protection in various types of limit dampers in processing machinery.

Yet another example where energy absorbers are used is in landing gears of aircraft.

In many cases where it is desirable to absorb energy generated during a collision (or impact) in order to avoid biological or mechanical damage it is not known beforehand how severe the collision (or impact ) will be. This means that in many cases the energy absorbing mechanisms is designed according to some special cases, such as statistically likely events.

For example, in “Development of Whiplash Associated Disorders for Male and Female Car Occupants in Cars Launched since the 80s in Different Impact Directions” in IRCOBI Conference 2013 by Anders Kullgren, et al. it is concluded that current whiplash protection in cars generally are less effective for women than men.

In light of the foregoing, there is thus a need for a flexible energy absorbing mechanism.

### SUMMARY

One object of the present invention is therefore to provide a flexible energy absorbing mechanism.

In the case of prevention of whiplash injuries the energy absorption depends on the conditions at the moment of collision, such as the speed difference between the colliding vehicles, the vehicle mass, and the mass of the seat occupant. Such parameters influence the severity of the collision (or impact). It has therefore been realized that the energy absorbing mechanism should be made adaptable to the severity of the collision (or impact).

A particular object of the present invention is therefore to provide a flexible energy absorbing mechanism with an ability to adapt its energy absorbing capacity so as to minimize the risk of damage caused by the collision (or impact). For example, the energy absorbing capacity may be adaptable to minimize the risk of damage caused by the collision (or impact) for different severities of the collision (or impact), and for different body sizes and masses where a human being is involved in the collision (or impact).

According to a first aspect there is thus provided an energy absorber. The energy absorber comprises a bar extending along a longitudinal axis and arranged to be moved along the longitudinal axis upon a tensile force acting on the bar along the longitudinal axis. The energy absorber comprises a first energy absorbing means and a second energy absorbing means extending along the longitudinal axis. The energy absorber comprises a coupling mechanism for coupling the second energy absorbing means to the bar. The bar is arranged to activate energy absorption of the first energy absorbing means upon movement of the bar along the longitudinal axis. The coupling mechanism comprises at least one force transferring element arranged to transfer force from the bar to the second energy absorbing means upon activation by at least one trigger element. The trigger element is arranged to be subjected to a trigger load as the bar is moved along the longitudinal axis, wherein the trigger load is proportional to velocity of the bar such that a higher velocity results in a higher trigger load. The trigger element is displaceably arranged relatively its unloaded position upon loading and, simultaneously, constrained from displacing by a constraining force acting in opposite direction of the trigger load. The trigger element is arranged to be displaced for activating the force transferring element for coupling and activation of the second energy absorbing means to the bar when the velocity of the bar is higher than a first pre-determined non-zero amount.

Advantageously this energy absorber provides a flexible energy absorbing mechanism.

Advantageously this energy absorber provides a flexible energy absorbing mechanism with an ability to adapt its energy absorbing capacity.

Such an energy absorber may be suitable for use in situations where energy needs to be mechanically absorbed. Examples include, but are not limited to, absorption of energy generated during car collisions so as to suppress the collision forces, absorption of energy resulting from forces generated between the landing gear and the ground runway during landing of aircraft (i.e., at the impact of the landing gear and the runway), absorption of energy in seatbelts, enhancement of absorption of energy in a beam element, and absorption of energy in processing machinery.

According to one embodiment the energy absorber comprises a bar extending along a longitudinal axis and arranged to be moved along the longitudinal axis upon a force acting on the bar along the longitudinal axis, where, according to the first aspect, the force is a tensile force. The energy absorber comprises a first energy absorbing means and a second energy absorbing means extending along the longitudinal axis. The energy absorber comprises a coupling mechanism for coupling the second energy absorbing means to the bar. The bar is arranged to activate energy absorption of the first energy absorbing means upon movement of the bar along the longitudinal axis. The bar and the coupling mechanism are arranged such that movement of the bar along the longitudinal axis causes a rotation of the coupling mechanism about the longitudinal axis. The coupling mechanism is arranged to activate energy absorption of the second energy absorbing means by coupling the second energy absorbing means to the bar when the rotation of the coupling mechanism is faster than a first predetermined non-zero amount. The energy absorber thus has the ability to sequentially engage the energy absorbing means one after another.

According to one embodiment the bar is threaded and splined, and the second coupling mechanism is arranged to be rotated about the longitudinal axis upon said force acting on the bar along the longitudinal axis. Hence, according to this embodiment, the energy absorber comprises a translating (non-rotating) bar and a rotating ring; the bar is prevented from rotating and the rotating ring rotates until a velocity exceeds the first predetermined non-zero amount. Then the rotating ring engages with splines of bar and stops rotating, thus activating energy absorption of the second energy absorbing means.

According to one embodiment the bar is threaded, and the bar is arranged to be rotated about the longitudinal axis upon said force acting on the bar along the longitudinal axis. Hence, according to this embodiment, the energy absorber comprises a rotating bar and coupling means of the rotating bar engages with a non-rotating second energy absorbing means.

According to a second aspect there is provided a mechanically energy absorbing vehicle seat comprising at least one energy absorber according to the first aspect.

It is to be noted that any feature of the first and second aspects may be applied to any other aspect, wherever appropriate. Likewise, any advantage of the first aspect may equally apply to the second aspect, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIGS. 1a-1g schematically illustrate different views of an energy absorber according to a first embodiment;

FIGS. 2a-2g schematically illustrate different views of an energy absorber according to a second embodiment;

FIGS. 3a-3h schematically illustrate different views of an energy absorber according to a third embodiment;

FIGS. 4a-4b schematically illustrate different views of an energy absorber according to a fourth embodiment;

FIGS. 5a and 5b schematically illustrate energy absorbing means;

FIG. 6 schematically illustrates a vehicle seat;

FIG. 7 schematically illustrates a vehicle;

FIGS. 8a-8c show simulation results;

FIG. 9 schematically illustrates a view of an energy absorber according to a sixth embodiment; and

FIG. 10 schematically illustrates a seatbelt in relation to a vehicle seat.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

In general terms, there is provided an energy absorber which may be regarded as a mechanical adaptive damping mechanism. In general terms, the energy absorption may be achieved by a plurality of energy absorbing elements placed in series along the longitudinal direction of a bar. The energy absorber may consist of a bar and a plurality of pistons to act on the energy absorbing elements.

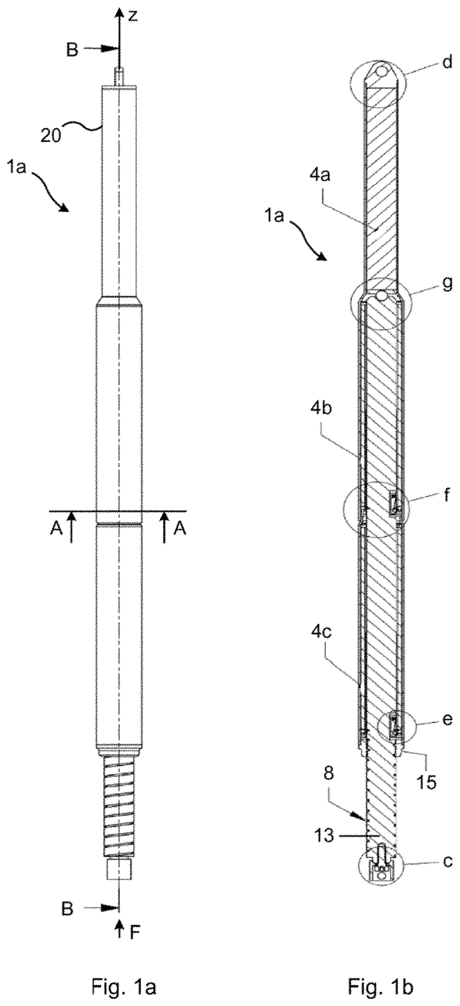

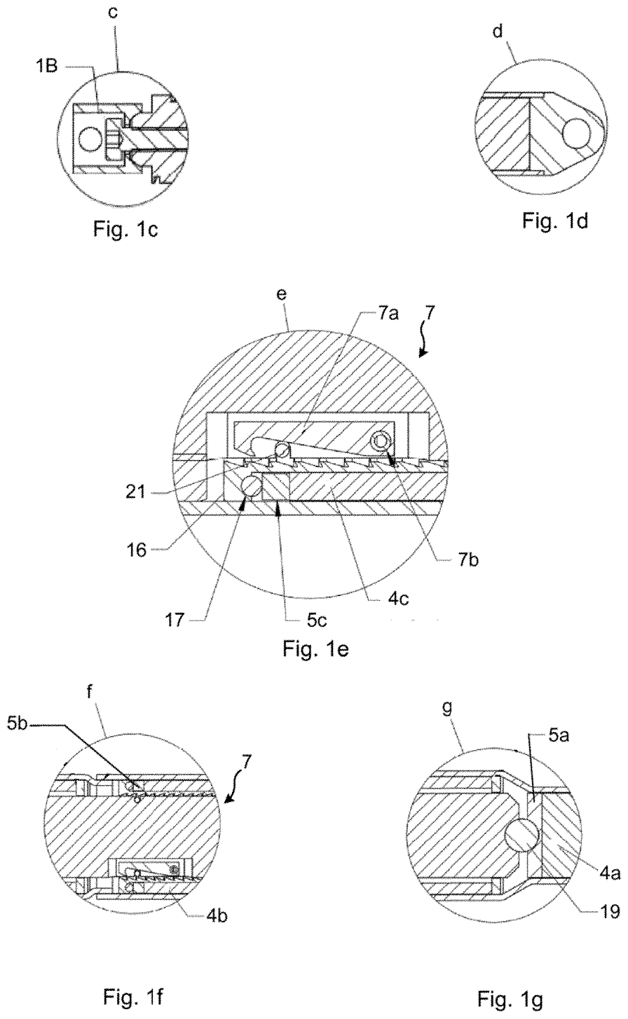

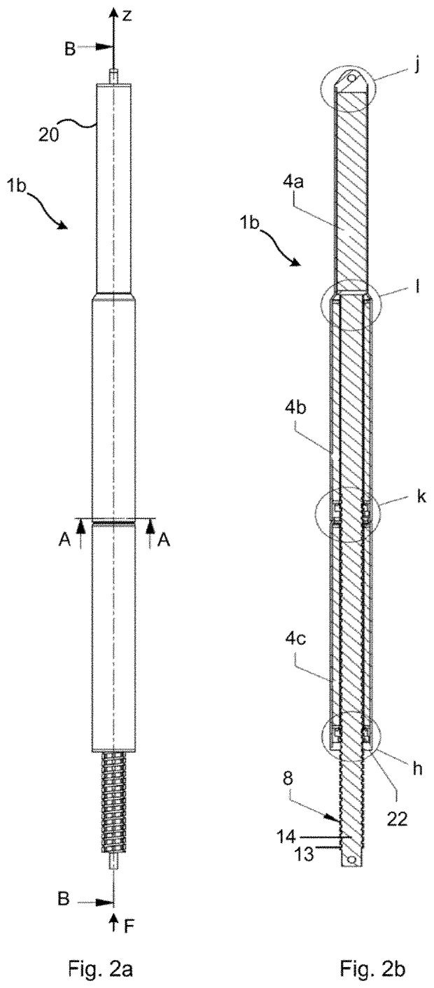

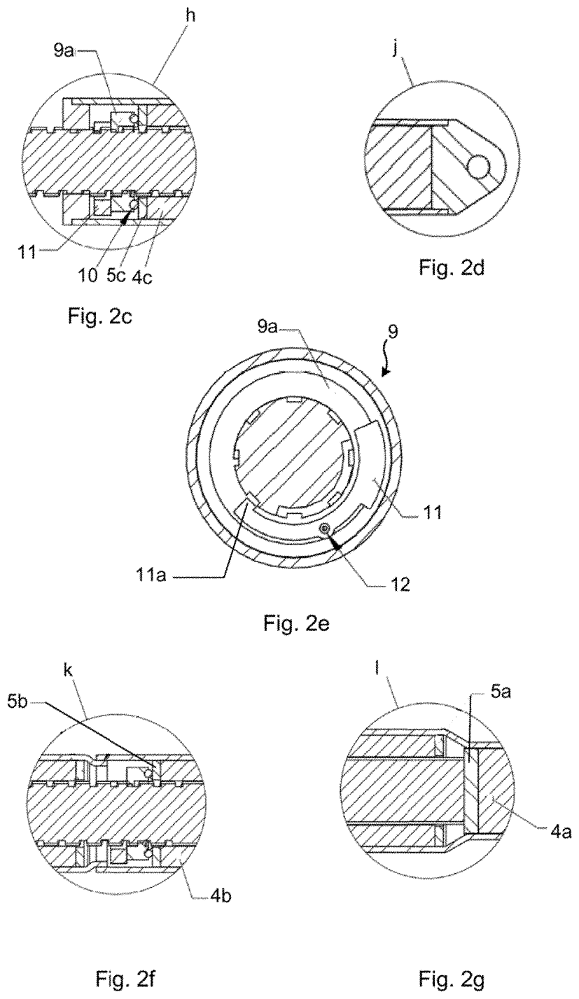

Reference is now made to FIGS. 1a, 1b, 1c, 1d, 1f, 1g, 2a, 2b, 2c, 2d, 2e, 2f, 2g, 3a, 3b, 3c, 3d, 3e, 3f, 3g, 3h, 4a, 4b schematically illustrating an energy absorber and parts thereof according to embodiments. FIG. 1a is a side view of an energy absorber 1a according to a first embodiment. FIG. 1b is a cross-sectional view of the energy absorber 1a of FIG. 1a taken at the cut B-B in FIG. 1a. FIG. 1c is a cross-sectional view of part c of the energy absorber 1a of FIG. 1b. FIG. 1d is a cross-sectional view of part d of the energy absorber 1a of FIG. 1b. FIG. 1e is a cross-sectional view of part e of the energy absorber 1a of FIG. 1b. FIG. 1f is a cross-sectional view of part f of the energy absorber 1a of FIG. 1b. FIG. 1g is a cross-sectional view of part g of the energy absorber 1a of FIG. 1b. FIG. 2a is a side view of an energy absorber 1b according to a second embodiment. FIG. 2b is a cross-sectional view of the energy absorber 1b of FIG. 2a taken at the cut B-B in FIG. 2a. FIG. 2c is a cross-sectional view of part c of the energy absorber 1b of FIG. 2b. FIG. 2d is a cross-sectional view of part d of the energy absorber 1b of FIG. 2b. FIG. 2e is a cross-sectional view of part e of the energy absorber 1b of FIG. 2b taken at the cut A-A in FIG. 2a. FIG. 2f is a cross-sectional view of part f of the energy absorber 1b of FIG. 2b. FIG. 2g is a cross-sectional view of part g of the energy absorber 1b of FIG. 2b.

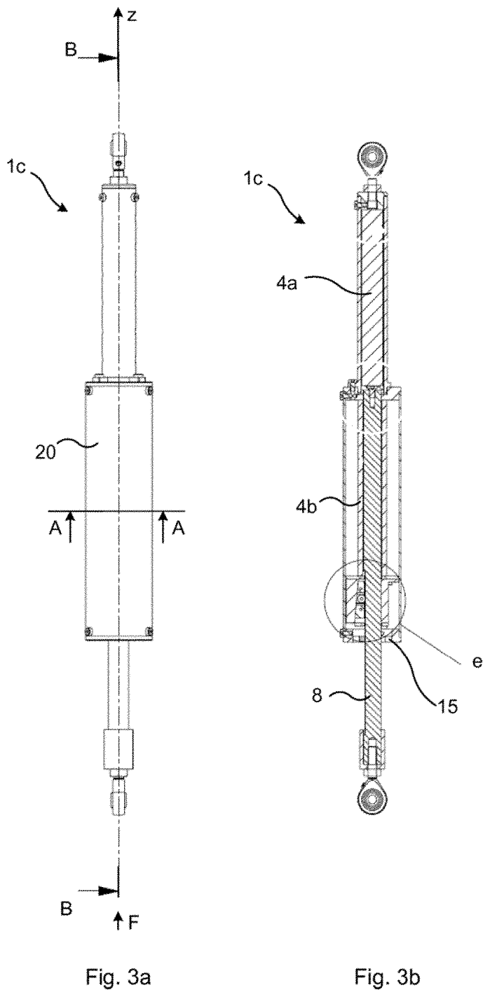

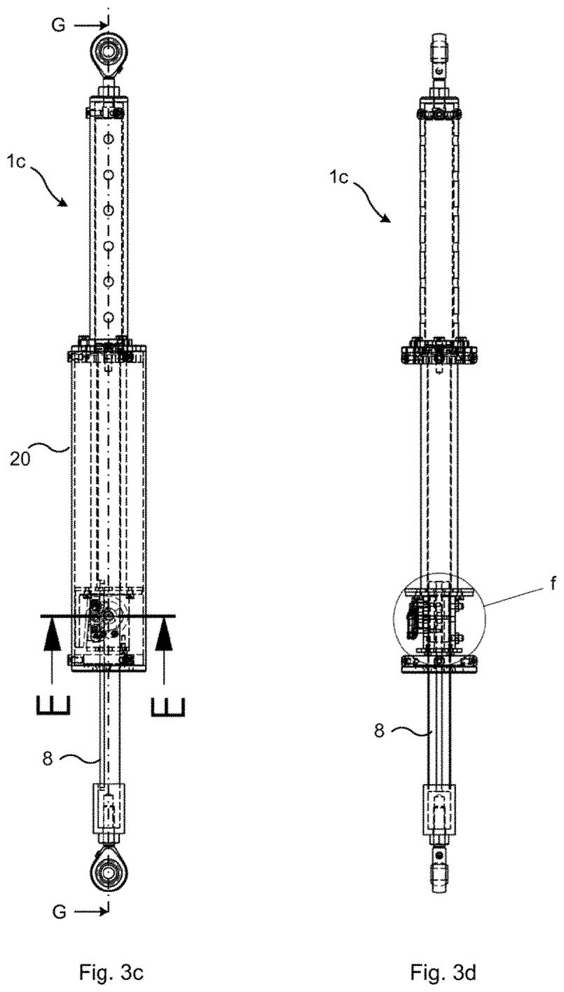

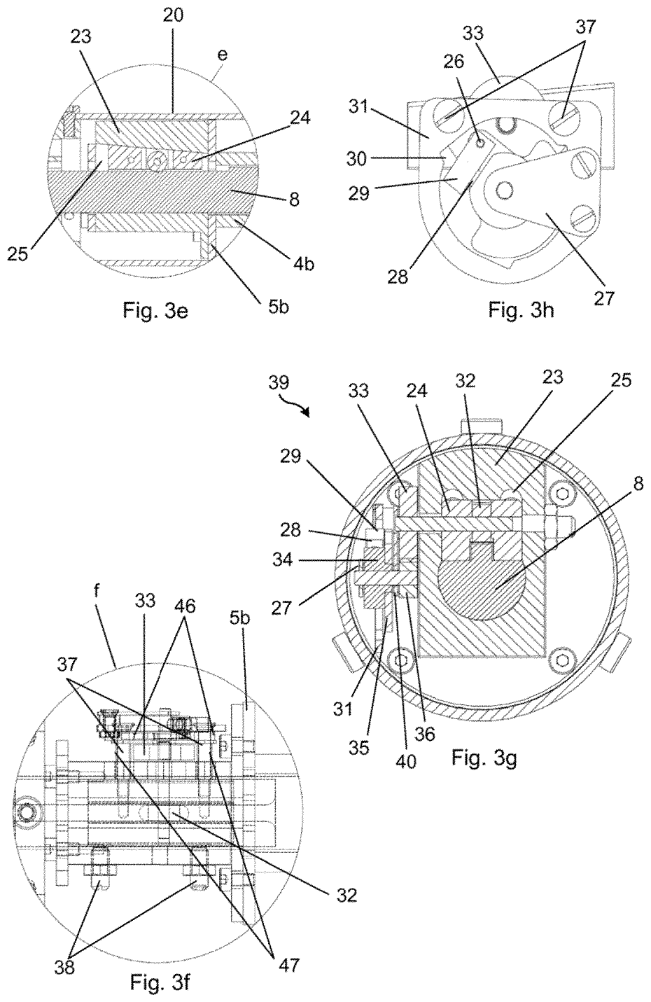

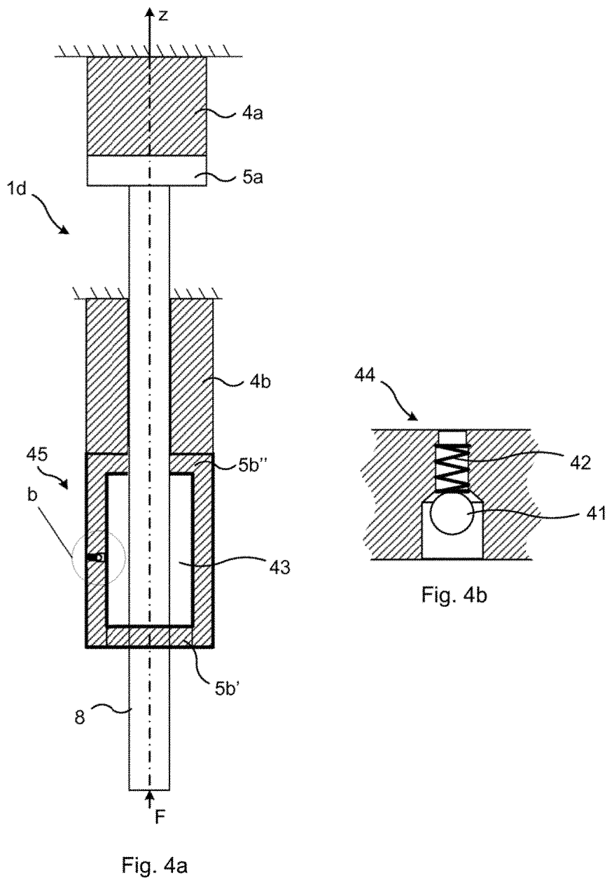

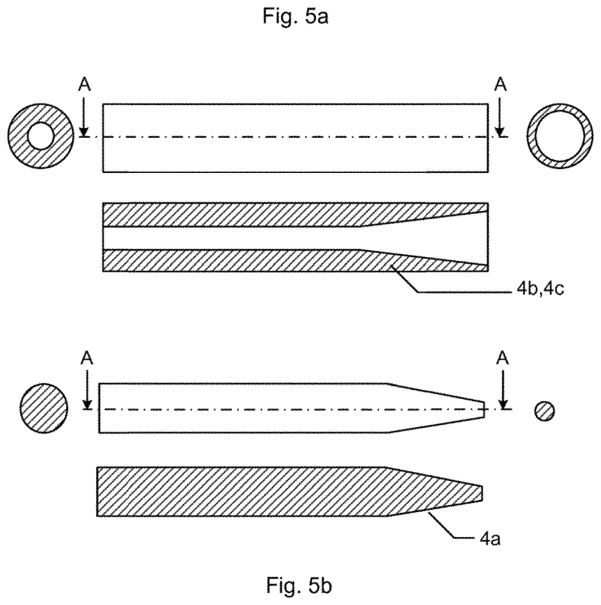

FIG. 3a is a side view of an energy absorber 1c according to a third embodiment. FIG. 3b is a cross-sectional view of the energy absorber 1c of FIG. 3a taken at the cut B-B in FIG. 3a. FIG. 3c is a further cross-sectional view of the energy absorber 1c of FIG. 3a. FIG. 3d is a cross-sectional view of the energy absorber 1c of FIG. 3a taken at the cut G-G in FIG. 3c. FIG. 3e is a cross-sectional view of part e of the energy absorber 1c of FIG. 3b. FIG. 3f is a cross-sectional view of part f of the energy absorber 1c of FIG. 3d. FIG. 3g is a cross-sectional view of part of the energy absorber 1e of FIG. 3c taken at the cut E-E in FIG. 3c. FIG. 3h is a side view of part f of the energy absorber 1c of FIG. 3f. FIG. 4a is a cross-sectional view of an energy absorber 1d according to a fourth embodiment. FIG. 4b is a cross-sectional view of part b of the energy absorber 1d of FIG. 4a.

The energy absorber 1a, 1b, 1c, 1d comprises a bar 8. The bar 8 extends along a longitudinal axis z. The bar 8 is arranged to be moved along the longitudinal axis z when a force F acts on the bar 8 along the longitudinal axis z. As will be further disclosed below, the bar 8 may be rotatably or non-rotatably arranged about the longitudinal axis z.

In order to absorb energy the energy absorber 1a, 1b, 1c, 1d is provided with energy absorbing means. Particularly, the energy absorber 1a, 1b, 1c, 1d comprises a first energy absorbing means 4a and a second energy absorbing means 4b. As will be further disclosed below the energy absorber 1a, 1b, 1c, 1d may comprise at least one further energy absorbing means 4c. The first energy absorbing means 4a and the second energy absorbing means 4b extend along the longitudinal axis z. Hence the first energy absorbing means 4a and the second energy absorbing means 4b may be regarded as placed in series along the longitudinal axis z.

The bar 8 is arranged to be moved along the longitudinal axis z inserted through at least the second energy absorbing means 4b. Further, the bar 8 is arranged to activate energy absorption of the first energy absorbing means 4a upon movement of the bar 8 along the longitudinal axis z. The bar 8 may be arranged to activate energy absorption of the first energy absorbing means 4a directly upon movement of the bar 8 along the longitudinal axis z or only after having been moved a certain distance along the longitudinal axis z.

The second energy absorbing means 4b and the bar 8 are mechanically connected by means of a coupling mechanism 7, 9, 39, 45. Particularly, the energy absorber 1a, 1b, 1c, 1d comprises a first energy absorbing means 4a and a second energy absorbing means 4b. As will be further disclosed below the energy absorber 1a, 1b, 1c, 1d comprises a coupling mechanism 7, 9, 39, 45 for coupling the second energy absorbing means 4b to the bar 8. The coupling mechanism 7, 9, 39, 45 comprises at least one force transferring element. The at least one force transferring element is arranged to transfer force from the bar 8 to the second energy absorbing means 4b upon activation by at least one trigger element.

The trigger element is arranged to be subjected to a trigger load as the bar 8 is moved along the longitudinal axis z. The trigger load is (linearly or nonlinearly) proportional to the velocity of the bar 8 such that a higher velocity results in a higher trigger load. As will be further disclosed below, the trigger load may be created by a hydraulic or pneumatic pressure, by a magnetic field, or by a centrifugal force.

The trigger element is displaceably arranged relatively its unloaded position upon loading and, simultaneously, constrained from displacing by a constraining force acting in opposite direction of the trigger load. The constraining force acting in the opposite direction of the trigger load may be provided by a pin, spring, wire, adhesive, magnet, weld, soldering, friction element, or any combination thereof.

The trigger element is arranged to be displaced for activating the force transferring element for coupling and activation of the second energy absorbing means 4b to the bar 8 when the velocity of the bar 8 is higher than a first pre-determined non-zero amount. Examples of elements and parameters determining the first predetermined non-zero amount will be further disclosed below.

As will be further disclosed below, the coupling mechanism 7, 9, 39, 45 may be provided on the bar 8 or on an element associated with the second energy absorbing means 4b.

Further, the bar 8 and the coupling mechanism 7, 9, 39, 45 may be arranged such that movement of the bar 8 along the longitudinal axis z causes a rotation of the coupling mechanism 7, 9, 39, 45 about the longitudinal axis z. However, as will be further disclosed below, also other arrangements of the bar 8 and the coupling mechanism 7, 9, 39, 45 are possible.

The coupling mechanism 7, 9, 39, 45 between the bar 8 and at least the second energy absorbing means 4b may thus be triggered by movement of the bar 8 along the longitudinal axis z. Particularly, the coupling mechanism 7, 9, 39, 45 may be arranged to activate energy absorption of the second energy absorbing means 4b by coupling the second energy absorbing means 4b to the bar 8 when the rotation of the coupling mechanism 7, 9, 39, 45 is faster than the first predetermined non-zero amount.

The energy absorber 1a, 1b, 1c, 1d thus has the ability to sequentially engage the energy absorbing means 4a, 4b, 4c one after another. For example, at a force F being applied corresponding to a rotation of the coupling mechanism 7, 9, 39, 45 not faster than the first predetermined non-zero amount at most the first energy absorbing means 4a is engaged. Upon the bar 8 having been moved a certain distance along the longitudinal axis z the first energy absorbing means 4a is engaged. This certain distance may be a zero distance. Then, once the force F being applied corresponds to a rotation of the coupling mechanism 7, 9, 39, 45 faster than the first predetermined non-zero amount also the second energy absorbing means 4b is engaged. Further, as will be disclosed below, once the force F being applied corresponds to a rotation of the coupling mechanism 7, 9, 39, 45 faster than a second predetermined non-zero amount, larger than the first predetermined non-zero amount, also a third energy absorbing means 4c may be engaged, and so on.

Details of how the bar 8 may be arranged to activate energy absorption of the second energy absorbing means 4b will now be disclosed in more detail.

For example, activation may be achieved by means of a centrifugal coupling mechanism 7, 9, 39, 45 provided between the bar 8 and the coupling mechanism 7, 9, 39, 45. Particularly, the coupling mechanism 7, 9, 39, 45 may be a centrifugal coupling mechanism 7, 9, 39, 45. The bar 8 may then be arranged to activate energy absorption of the second energy absorbing means 4b by means of the centrifugal coupling mechanism 7, 9, 39, 45. For example, the centrifugal coupling mechanism 7, 9, 39, 45 may comprise a trigger element. The trigger element is radially displaceable upon rotation of the coupling mechanism 7, 9, 39, 45 about the longitudinal axis z and when the centrifugal force acting on the trigger element exceeds a value. This value generally depends on the first predetermined amount and the mass (and/or mass distribution) of the trigger element.

For example, the trigger element may be arranged to be radially displaceable relatively the longitudinal axis upon an additional rotation about an axis oblique to, and radially off-set from, the axis of rotation caused by the movement of the bar. For example, the trigger element may be arranged to be radially displaceable relatively its axis of rotation by a translating motion, wherein its center of gravity is radially off-set from the axis of rotation caused by the movement of the bar.

Radial displacement of the trigger element may be achieved by rotating the trigger element about an axis that is parallel with, and radially off-set from, the longitudinal axis z of the bar 8. Particularly, the trigger element may be arranged to be radially displaceable upon rotation of the trigger element about an axis parallel with, and radially off-set from, the longitudinal axis z. Alternatively, radial displacement of the trigger element may be achieved by-rotating the trigger element about an axis that is perpendicular to, and radially off-set from, the longitudinal axis z of the bar 8. Particularly, the trigger element may be arranged to be radially displaceable upon rotation of the trigger element about an axis perpendicular to, and radially off-set from, the longitudinal axis z.

Radial displacement of the trigger element may be constrained, such that the trigger element is constrained from being radially displaced below a rotational speed corresponding to the first predetermined non-zero amount. Particularly, the centrifugal coupling mechanism 7, 9, 39, 45 may comprise a constraining element. The constraining element is arranged to prevent the trigger element from being radially displaceable upon rotation of the coupling mechanism 7, 9, 39, 45 about the longitudinal axis z not faster than the first predetermined non-zero amount.

One end of each energy absorbing means may be axially fixed. Thus, as the bar 8 moves along the longitudinal axis z one end of the each energy absorbing means stays fixed. The other end of each energy absorbing means may, upon its energy absorption being engaged, move with the bar 8 along the longitudinal axis z, thus forcing the energy absorbing means to be mechanically compressed.

The energy absorber 1a, 1b may further comprise piston elements 5a, 5b, 5c. Each energy absorbing means 4a, 4b, 4c may be associated with a respective piston element 5a, 5b, 5c. However, it may be possible that less than all of the energy absorbing means 4a, 4b, 4c are associated with a respective piston element 5a, 5b, 5c. Each piston element 5a, 6b, 5c may be axially fixed at one of its ends.

The activation of the energy absorbing means 4a, 4b, 4c may be achieved by coupling the bar 8 to a piston element 5a, 5b, 5c pressurizing the energy absorbing means 4a, 4b, 4c in the axial direction. Particularly, the bar 8 may be arranged to activate energy absorption of each energy absorbing means 4a, 4b, 4c by engaging with the respective one of the piston elements 5a, 5b, 5c, wherein the engaging causes each piston element 5a, 5b, 5c to pressurize its respective energy absorbing means 4a, 4b, 4c.

The energy absorbing means may be pressurized in a particular order. For example, the first energy absorbing means 4a may be pressurized before the second energy absorbing means 4b is pressurized. The energy absorber 1a, 1b may so be constructed that one of the pistons always is in contact with its corresponding energy absorbing means whilst the other piston(s) may at given condition be activated so as to pressurize their corresponding energy absorbing means. Particularly, the piston element 5a of the first energy absorbing means 4a may be axially fixed relative the longitudinal axis z such that the first energy absorbing means 4a is pressurized before the second energy absorbing means 4b as a result of the force F acting along the longitudinal axis z. Further piston elements 5b, 5c may then be axially coupled in turn so as to activate its corresponding energy absorbing means 4b, 4c. Particularly, the piston element 5b of the second energy absorbing means 4b may be arranged to be axially fixed relative to the bar 8 upon the second energy absorbing means 4b being activated by the bar 8.

Five particular embodiments will now be described.

Particular references are now made to FIGS. 1a-1g illustrating an energy absorber 1a and parts thereof according to a first embodiment. The first embodiment is based on a threaded rotating bar 8. The first predetermined non-zero amount may be dependent on a lead value of the thread 13 of the bar 8. In more detail, the maximum speed (i.e., the gear ratio between the axial speed and rotational speed of the bar 8) the bar 8 will achieve depends on the lead of the thread 13; the smaller the lead the higher the rotational speed. The limiting case is when the thread 13 will be self-locking.

According to the first embodiment the coupling mechanism 7 is provided on the bar 8 and upon rotation of the bar 8 the coupling mechanism 7 engages with a non-rotating piston element 5a, 5b, 5c. The bar 8 is rotated about the longitudinal axis z when forced to move in the axial direction (i.e. along the longitudinal axis z) upon the force F acting on the bar 8. Hence, according to the first embodiment the bar 8 is arranged to be rotated about the longitudinal axis z upon the force F acting on the bar 8 along the longitudinal axis z.

According to the first embodiment the rotation may be achieved by moving the non-rotating bar 8 through an axially supported nut 15. Hence the energy absorber 1a may further comprise an axially supported nut 15. The bar 8 is then arranged to be rotated about the longitudinal axis z when moved through the nut 15 upon the force F acting on the bar 8 along the longitudinal axis z. The bar 8 is thus brought into rotation by its engagement with the axially fixed nut 15. Rolling elements may be provided at the interface of the bar and the nut such as to reduce friction.

According to the first embodiment the piston element 5b of the second energy absorbing means 4b is connected to its force activating element through a joint enabling rotation between the force activating element and the piston 5b. Particularly, the energy absorber 1a may further comprise an engagement cup 16 axially coupled to the piston element 5b of the second energy absorbing means 4b through a thrust bearing 17. The above disclosed trigger element may then be provided on the bar 8 and arranged to engage with the engagement cup 16 upon being rotated about the longitudinal axis z faster than the first predetermined non-zero amount. The trigger element thereby enables the bar 8 to engage with the piston element 5b of the second energy absorbing means 4b so as to pressurize, and thereby activate, the second energy absorbing means 4b.

According to the first embodiment the trigger element is thereby arranged to rotate about the longitudinal axis z of the bar 8 as the bar 8 is displaced in the longitudinal direction and thus brought into rotation by its engagement with the axially fixed nut 15. The trigger element may be an axially extending trigger element, such as at least one engagement hook 7a, each one of which is coupled to the bar 8 by a fulcrum pin 7b.

According to the first embodiment the trigger element is displaceable in the radial direction of the bar 8 through rotation about an axis that is perpendicular to the longitudinal direction of the bar 8. The axis is also radially off-set from the longitudinal axis z of the bar 8.

According to the first embodiment the trigger element may be restrained from displacing in the radial direction of the bar 8 by a centrifugal force depending means, such as a Garter spring 21. At a certain rotational speed of the bar 8, the centrifugal force on the trigger element, caused by the rotation of the trigger element, will exceed the restraining force of the restraining element and thus the engagement hook 7a will displace in the radial direction of the bar 8 through rotation about the fulcrum pin 7b, i.e. about an axis that perpendicular to the longitudinal axis z of the bar 8.

According to the first embodiment, in general terms, the restraining force of the Garter spring 21 in conjunction with the mass and placement radius of the engagement hook 7a, decide at what shaft velocity the engagement hook 7a should engage. The very same type of Garter spring 21 may be used to tune trigger elements of the second and third energy absorbing means 4b, 4c (see below for description of the third energy absorbing means 4c) to different velocities. For example, by displacing the groove in which the Garter spring 21 resides axially, different leverage between the engagement hook 7a and the Garter spring 21 is achieved, causing the different energy absorbing means to engage at different velocities. By using the same type of Garter spring 21 in all trigger elements, the possibility of a mistake during assembly of the energy absorber 1a is also minimized.

According to the first embodiment, as the trigger element displaces in the radial direction, it thus engages with the engagement cup 16, axially connected to a piston element 5b, 5c through the thrust bearing 17. The engagement cup 16 may be serrated along its inner sides. The engagement hook 7a of the trigger element may grip the serrations of the engagement cup 16, thus connecting the bar 8 with the piston element 5b, 5c. As the engagement cup 16 is connected to the trigger element it will be brought into rotation. In more detail, the centrifugal force acting on the engagement hook 7a will “lift” the engagement hook 7a at a certain velocity, causing the engagement hook 7a to engage with the engagement cup 16. The engagement cup 16 may be serrated on the inside and have a flange that is bearing against a washer 5c via a number of steel balls. The washer 5c is resting on the second energy absorbing means 4b. As the engagement hook 7a is lifted, it grips into the serrations on the inside of the engagement cup 16, dragging the engagement cup 16 along. As the bar 8 and the engagement hook 7a are rotating, the engagement cup 16 is also brought into rotation. Steel balls may reduce the friction whilst at the same time transfer the force F to the second energy absorbing means 4b.

According to the first embodiment one end of the bar 8 may be provided with a swivel joint attachment 18 for translating a non-rotational movement to a rotational movement upon the force F acting on the bar 8 along the longitudinal axis z. The other end of the bar 8 may be provided with a thrust bearing 19 for interconnecting the first energy absorbing means 4a and the second energy absorbing means 4b.

Particular references are now made to FIGS. 2a-2g illustrating an energy absorber 1b and parts thereof according to a second embodiment. The second embodiment is based on a threaded and splined non-rotating bar 8. The splines 14 (i.e., longitudinal grooves) of the bar 8 may be shallower than the threads 13 of the bar 8, for example to ensure the threaded functionality and thus to leave ample thread flanks available for the threaded functionality. An end cap 22 of the bar 8 may be provided with teeth running in the splines 14 so as to prevent rotation of the bar 8 during longitudinal displacement. The threaded bar 8 is thus prevented from rotating by a number of splines 14 along the bar 8. The splines 14 engage the end cap 22 and the threaded bar 8 is thus locked in rotation.

According to the second embodiment the bar 8 is non-rotating when forced to move in the axial direction. Movement of the bar 8 in the longitudinal direction causes the coupling mechanism 9 to be rotated. When the rotation velocity of the coupling mechanism 9 exceeds the first predetermined non-zero amount (as defined above) the rotating coupling mechanism 9 engages with splines 14 of bar 8 and stops rotating, thus activating the second energy absorbing means 4b. Particularly, the coupling mechanism 9 is arranged to be rotated about the longitudinal axis z upon the force F acting on the bar 8 along the longitudinal axis z.

According to the second embodiment the rotation may be achieved by moving the non-rotating bar 8 through an axially supported threaded trigger ring 9a. As the bar 8 is displaced in the longitudinal direction, the trigger ring 9a is forced to rotate through its threaded connection with the bar 8. Particularly, the coupling mechanism 9 may comprises the axially supported threaded ring 9a. The coupling mechanism 9 may then be arranged to be rotated about the longitudinal axis z when the bar 8 is moved through the threaded ring 9a when the force F acts on the bar 8 along the longitudinal axis z. Rolling elements may be provided at the interface of the bar and the nut such as to reduce friction.

According to the second embodiment the piston element 5b of the second energy absorbing means 4b is connected to its force activating element through a joint enabling rotation between the force activating element and the piston. Particularly, the energy absorber 1b may further comprise a thrust bearing 10 interconnecting the threaded ring 9a to the piston element 5b of the second energy absorbing means 4b. The threaded ring 9a, in turn, may thus be coupled to the piston element 5b of the second energy absorbing means 4b through a thrust bearing 10, allowing for a rotational motion between the threaded trigger ring 9a and the piston element 5b when the trigger element is not activated. When the trigger element engages with splines of the bar 8, the piston element 5b will activate the second energy absorbing means 4b trough an axial force. Particularly, the coupling mechanism 9 may be provided on the second energy absorbing means 4b, and the trigger element may be arranged to engage with splines 14 of the bar 8 upon being rotated about the longitudinal axis z faster than the first predetermined non-zero amount. The piston element 5b of the second energy absorbing means 4b thereby engages with the bar 8 so as to pressurize and thereby activate the second energy absorbing means 4b.

According to the second embodiment the thrust bearing to may further enable rotational motion between the threaded ring 9a and the piston element 5b of the second energy absorbing means 4b when the rotation of the coupling mechanism 9 is not faster than the first predetermined non-zero amount. Engagement of the second energy absorbing means 4b may thereby be prevented below a rotation motion corresponding to the first predetermined non-zero amount.

According to the second embodiment the trigger element may be a trigger arm 11 coupled to the threaded ring 9a by a fulcrum pin 12. In more detail, at least one circumferentially extending rotatable trigger element may be fixed to a gable end of the threaded ring 9a through a fulcrum pin 12. The trigger element may be radially displaceable through a first rotation about the longitudinal axis z of the bar 8; and through a second rotation about a second axis that is parallel with the longitudinal axis z of the bar 8 and radially off-set from the longitudinal axis z of the bar 8. It may be held in position by a centrifugal force depending radial displacement restraining element (not shown in the figures). At a certain translational speed of the bar 8, the centrifugal force on the trigger element, caused by the rotation of the threaded ring 9a, will exceed the restraining force of the restraining element thus the trigger element will displace in the radial direction of the bar 8 through rotation about the fulcrum pin 12, i.e., about an axis that is parallel with the longitudinal axis z of the bar 8. Further, the trigger element may be constructed to engage with the splines 14 in the bar 8 through a hook 11a. As the hook 11a engages with the bar 8, rotation of the trigger element will be prevented, i.e., the trigger element will be coupled to the bar 8 in the axial direction. The trigger element may have a mass distribution securing engagement with the splines 14 when the rotational speed exceeds the first predetermined non-zero amount. Thus, as the bar 8 is moved along the longitudinal axis z, the thread will bring the threaded ring 9a into rotation, and with it the trigger arm 11. As the centrifugal force on the trigger arm 11 exceeds a certain value, it rotates around the fulcrum pin 12 and its hooked end 11a engages one of the splines 14. This locks the rotation of the threaded ring 9a, in effect forcing it to follow the longitudinal movement of the bar 8. The longitudinal movement of the threaded ring 9a thus causes the second energy absorbing means 4b to be engaged.

Particular references are now made to FIGS. 3a-3g illustrating an energy absorber 1c and parts thereof according to a third embodiment.

According to the third embodiment the bar 8 is a toothed rack. The trigger element may then be arranged to be rotated about an axis perpendicular or oblique to the longitudinal axis upon the force acting on the bar along the bar along the longitudinal axis.

According to the third embodiment the coupling mechanism 39 comprises a base body 23 with a lengthwise provided cavity 25 to accommodate both the toothed bar 8 and a load transferring element in the form of a wedge 24 (herein also referred to as a wedge element). The base body and the wedge thus constitute a wedge joint.

According to the third embodiment a piston 5b is arranged at one of the ends of the base body and is axially coupled to the second energy absorbing means 4b upon activation of the wedge. The wedge element is initially (in an unloaded state) positioned such that it is not in contact with the bar. The initial position is controlled by two set screws 38 fixed in the base body with a spring loaded ball front positioned eccentrically in conical holes of the wedge. In general terms, the wedge element may be initially positioned by at least one set screw 38 comprising a spring loaded spherical front positioned eccentrically in a conical hole of the wedge and supported by the base body such that a movement in the axial direction of the set screw 38 will position the wedge such that a gap is created between the surface of the bar and the wedge. As the screw (or screws) are tightened the wedge will move such that a small gap is created between the flat surfaces of the bar and the wedge. The second energy absorbing element is thus not activated. Only the first energy absorbing elements is axially coupled to the bar.

According to the third embodiment the wedge element, placed in the cavity of the base body, comprises a cavity to accommodate a first gear wheel 32. The rotational axis of the gear wheel is oriented in a perpendicular direction of the longitudinal axis of the bar and arranged in wedge and base body. As the bar is moved along the longitudinal axis, the gear wheel is brought into rotation. That is, the toothed rack may be engaged with a gearwheel such that the movement of the bar along the longitudinal axis upon the force F acting on the toothed rack causes the gearwheel to rotate about an axis perpendicular or oblique to the longitudinal axis z. Further, the trigger element may be rotatably connected to the gearwheel such that a rotation of the gearwheel causes a first rotation of the trigger element about an axis perpendicular or oblique to the longitudinal axis z.

According to the third embodiment, at one of the ends of the rotational axis of the first gear wheel 32, a second gear wheel 33 is arranged and engaged with a third gear wheel 36 so as to create an upshifting of the rotational speed. The rotational axis of the first gearwheel 32 is arranged in a hole of the base body to ensure a certain play between the rotational axis and the base body. The rotational axis of third gear wheel 36 is supported by a support plate 40 and rotatably connected to a holder 35 for the trigger element. The brake plate 31 and support plate 40 are connected to the wedge through fixation screws 37. The fixation screws 37, anchored in the wedge 24, are provided to extend through the holes of the brake plate 31, the support plate 40 and the base body 23. The fixation screws 37 are also provided to extend through a pair of sleeves 46 separating the support plate 40 and the brake plate 31 and through another pair of sleeves 47 separating the base body 23 and the support plate 40. The sleeves 47 are arranged in the holes in the base body 23 with a certain play between the sleeves 47 and the base body 23. Such an arrangement will join the elements so as to allow for a small relative motion between the wedge 24 and the base body 23 upon a force acting on the wedge 24, the force being sufficiently large to overcome the small locking force provided by the spring loaded set-screws 38. The rotational axis of the third gear wheel 36 is also supported by the arm 27.

According to the third embodiment, as the bar is moved along the longitudinal axis, the holder 35, the trigger element 29 and the support body 34 will rotate and a centrifugal force is acting on the trigger element. The rotational axis of the trigger holder 35 and support body 34 is supported by an arm 27 connected to a brake plate 31. The trigger element rotates within an opening in a brake plate. The opening has three pockets along its periphery.

For example, rotation of the trigger element, caused by the movement of the bar, may be about an axis perpendicular or oblique to the longitudinal axis z of the bar. For example, the trigger element 29 may be arranged to be radially displaceable relatively the perpendicular or oblique axis upon an additional rotation about an axis parallel with, and radially off-set from, the perpendicular or oblique axis. For example, the trigger element may be arranged to be radially displaceable relatively the perpendicular or oblique axis upon a second rotation about an axis perpendicular to, and radially off-set from, the perpendicular axis or oblique axis.

According to the third embodiment the trigger element is displaceably arranged in the holder 35 upon an additional rotation about an axis perpendicular to the longitudinal axis of the bar when the centrifugal trigger force exceeds a certain value of a constraining force (a magnetic force) provided by a magnet 28 in this example anchored in the support body 34) acting in opposite direction of the trigger force.

According to the third embodiment, as the trigger element rotates about the axis 26, it will displace into a pocket 30 in the opening of the brake plate and abruptly stop the rotation of the trigger holder 35 and consequently the gear wheels and drive the wedge element in contact with the bar such that force is transferred from the bar to the second energy absorbing means.

That is, according to the third embodiment, the trigger element is arranged to rotate in the opening of a brake plate connected to the wedge, the opening having at least one radially extending pocket, and wherein the trigger element is displaceably mounted on a trigger holder 35 upon an additional rotation about an axis perpendicular to the longitudinal axis of the bar when the centrifugal force acting on the trigger element exceeds a certain value of a constraining force acting in the opposite direction of the trigger load, such as to engage with the radially extending pockets in the trigger holder 35, whereby the rotational motion of the gear wheels is stopped, driving the wedge in contact with the bar such that the force of the bar is transferred to the second energy absorbing means 4b.

Particular references are now made to FIGS. 4a and 4b illustrating an energy absorber 1d and parts thereof according to a fourth embodiment.

According to the fourth embodiment, as the bar 8 (and a piston 5a coupled to the bar 8) is moved along the longitudinal axis z, the first energy absorbing means 4a is axially coupled to the piston 5a. A further piston 5b′ is coupled to the bar 8. The coupling mechanism 45 of the second energy absorbing means 4b is in the form of a hydraulic cylinder 43. As the bar 8 is moved the longitudinal axis, a hydraulic flow is going through a ball check valve 44 as the piston 5b′ pressurizes the fluid in the hydraulic cylinder 43.

According to the fourth embodiment a ball 41 constitutes the trigger element of the coupling mechanism 45. The load on the ball (trigger load) depends on the pressure drop over the check valve 44. The pressure drop depends on the flow rate through the cheek valve 44 such as the higher the flow rate, the higher the pressure drop. The flow rate depends on the velocity of the bar 8; the higher the velocity, the higher the flow rate as long as the check valve is open.

According to the fourth embodiment the ball 41 is thus displaceably arranged relatively its unloaded position upon loading, and simultaneously constrained from displacing by a constraining force acting in opposite direction of the trigger load. The constraining force, in this case, is provided by the spring 42 of the ball check valve 44.

According to the fourth embodiment, at a bar velocity lower than a first pre-determined non-zero amount the second energy absorbing means 4b is not engaged as the flow will pass through the check valve 44. As the velocity increases to a value higher than the first pre-determined non-zero amount, the pressure in the hydraulic cylinder 43 increases such that the check valve 44 closes. At this point, force is transferred from the bar 8 to the second energy absorbing element 4b. In this case the hydraulic liquid constitutes the load transferring element. The gable of the cylinder 5b″ constitutes the piston acting on the second energy absorbing means 4b.

The principle above for at least the fourth embodiment could be applied by substituting the hydraulic liquid for a gas. As the liquid is incompressible whereas a gas is not, some difference may apply.

According to the fifth embodiment the trigger load is created based on the principle of a linear permanent magnet eddy current break. Hence, the coupling mechanism may comprise a magnet in relative motion with a nearby conductive object.

According to the fifth embodiment the force between a magnet and a conductive object in relative motion is utilized, due to eddy currents induced in the conductor through electromagnetic induction.

If for example a trigger element in the form of a permanent magnet is mounted on the bar and the bar is moved through the conductive object, electrical currents are generated in the conductor generating a magnetic field. According to Lenz's law the magnetic field will creates repulsive force acting on the trigger element. The force is dependent on the velocity of the bar.

The trigger element is simultaneously arranged to be constrained from displacing by a constraining force acting in opposite direction of the repulsive force. The trigger element is displaced for activating a force transferring element when the velocity of the bar and, consequently, the trigger force is higher than a first pre-determined non-zero amount. The force transferring elements may be a fluid, gas or a mechanical element.

According to the fifth embodiment the displacement may, in turn, be utilized to activate a load transferring element analogues with the previously disclosed embodiments.

The five embodiments described above have all at least implicitly been configured for load cases where the bar 8 is subjected to a compressive force F. There may, in addition, be applications where it is desired to configure the energy absorber 1a-1d for load cases where the bar is subjected to a tensile force. In such case, the mechanical design of the five embodiments needs to be modified such that that energy absorption is activated by a force and displacement acting in the same direction as the tensile force.

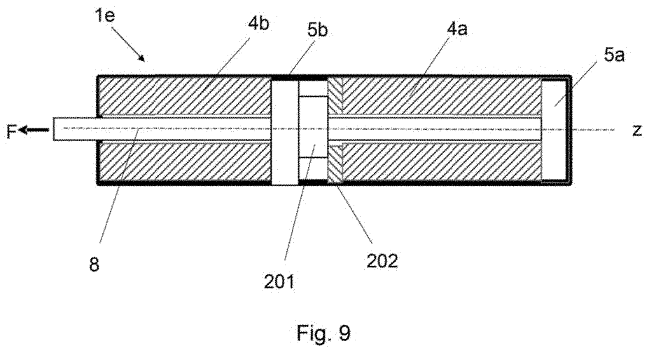

FIG. 9 is a cross-sectional view of a principal configuration of an energy absorber 1e according to a sixth embodiment, where the energy absorber 1e is configured for energy absorption in a case where the bar 8 is subjected to a tensile force F. The energy absorber 1e comprises a bar 8 extending along a longitudinal axis z. The bar 8 is arranged to be moved along the longitudinal axis upon a tensile force F acting on the bar 8 along the longitudinal axis z. A first energy absorbing means 4a and a second energy absorbing means 4b extend along the longitudinal axis z.

The energy absorber 1e comprises furthermore piston elements 5a, 5b. The piston element 5a is associated with the first energy absorbing means 4a and is coupled to the bar 8. Element 202 provides axial fixation of the first energy absorbing means 4a. The energy absorber 1e comprises furthermore a coupling mechanism 201 for coupling the second energy absorbing means 4b to the bar 8. The coupling mechanism 201 for coupling the second energy absorbing means 4b to the bar 8 is not shown in detail in FIG. 9. Examples of coupling mechanisms and other design details of the energy absorber 1e are identical with the ones described for the above disclosed five embodiments. The coupling mechanism 20a may thus be any of the above disclosed coupling mechanisms 7, 9, 39, 45.

As the bar 8 is subjected to the tensile force F of a certain magnitude it will activate energy absorption in the first energy absorbing means 4a. As in the embodiments described above, the coupling mechanism 201 (such as any of the coupling mechanisms 7, 9, 39, 45) comprises at least one force transferring element arranged to transfer force from the bar 8 to the second energy absorbing means 4b upon activation by a least one trigger element as disclosed above. As also disclosed above, the trigger element is arranged to be subjected to a trigger load as the bar 8 is moved along the longitudinal axis z. The trigger element is proportional to the velocity of the bar 8 such that a higher velocity results in a higher trigger load. The trigger element is displaceable arranged relatively its unloaded position upon loading and, simultaneously constrained from displacing by a constraining force acting in the opposite direction of the trigger load. The trigger element is arranged for activating the force transferring element for coupling of the second energy absorbing element 4b to the bar 8 when the velocity of the bar 8 is higher than a first pre-determined amount.

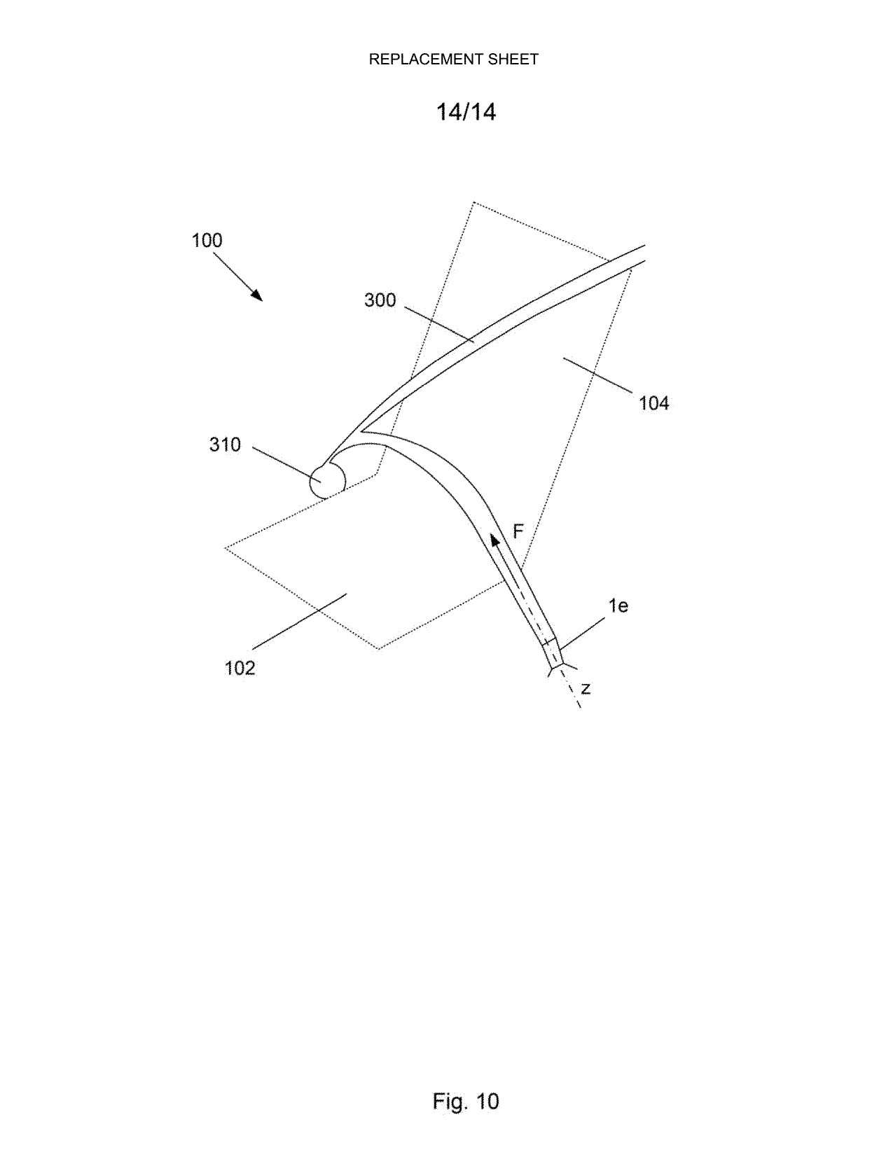

A non-limiting exemplary application where an energy absorber 1e as disclosed above may be used is in a seatbelt application. FIG. 10 schematically illustrates a seatbelt 300 in relation to a vehicle seat 100, where the seatbelt 300 is attached at a seatbelt fastener 310 (also known as a seatbelt buckle). The vehicle seat 100 comprises a seat 102 and a backrest 104. Further, the seatbelt 300 is attached to an energy absorber 1e. Particularly, according to the configuration of FIG. 10 the seatbelt 300 may either be attached to the bar 8 of the energy absorber 1e or to the distal end (in relation to the end at which the bar is configured to protrude from the energy absorber 1e) of the energy absorber, and where the other end of the energy absorber 1e is attached to an element of the vehicle in which the vehicle seat 100 is provided. Additionally or alternatively, an energy absorber 1e can form an integral part of a seatbelt pretensioner (such as a retractor pretensioner, a buckle pretensioner, or a lap pretensioner) at an anchorage point of the seatbelt 300.

The energy absorber 1e is thereby arranged to absorb energy when a tensile force F is applied to the seatbelt 300 along the longitudinal direction z of the energy absorber 1e. Hence, the energy absorber 1e may absorb energy caused by a seatbelt 300 being stretched, such as during a car accident, where the tensile force F thus represents stretching of the seatbelt 300.

In general terms, according to the first embodiment no force is carried by the thread 13 of the bar 8, whilst according to the second embodiment all the force is carried by the thread 13 of the bar 8. In general terms, according to the first embodiment the full force is carried by the engagement hook 7a, whilst according to the second embodiment the force one the engagement hook is reduced by the lead of the thread (about eight times lower, depending on thread lead).

Further details of the energy absorber 1a, 1b, 1c, 1d, 1e will now be disclosed in more detail.

In general terms, there may be several ways to affect the energy absorption of the energy absorber 1a, 1b, 1c, 1d, 1e.

One example is the total stroke; the longer the stroke, the more the energy may be absorbed. Assume that the energy absorber 1a, 1b, 1c, 1d, 1e is incorporated in a vehicle seat 100 (see below). Since the bar velocity in the energy absorber 1a, 1b, 1c, 1d, 1e is equal to the difference between the vehicle velocity and that of the seat occupant in the vehicle 200, the longer the stroke, the more the accelerations may be reduced, thereby reducing the risk of whiplash injuries of the seat occupant.

One example is the number of energy absorbing means 4a, 4b, 4c used. In general terms, using more energy absorbing means 4a, 4b, 4c will increase the possibility to fine tune the energy absorption.

One example is the trigger velocities to trigger the energy absorbing means 4a, 4b, 4c. The velocities at which the different energy absorbing means 4a, 4b, 4c engage affect the behavior of the energy absorption.

One example is the variation of the force at each energy absorbing means 4a, 4b, 4c (such as the type of energy absorbing material used in the energy absorbing means 4a, 4b, 4c and the cross section area of the energy absorbing means 4a, 4b, 4c). In more detail, there may be different examples of energy absorbing means. For example, the first energy absorbing means 4a and the second energy absorbing means 4b may comprise any of a solid material, a fluid material, a gaseous material, or any combination thereof. One example of a solid material is a foam material with good energy absorbing capacity. One example of a structural foam material with high energy absorbing capacity is the commercially available Divinycell HCP 100. For this material energy is absorbed as the internal structure of the foam crumples. The force required is relatively constant during such a collapse. The crushing tensile stress of Divinycell HCP 100 is approximately 12 MPa. By varying the cross section, different crushing forces will result. The material of the first energy absorbing means 4a may be the same as or different from the material of the second energy absorbing means 4b.

One example is the shape of the energy absorbing means. In more detail, it may be possible to shape the initial force characteristics of a specific energy absorbing means by tapering it over part of its length along the longitudinal axis z. FIG. 3a schematically illustrates tapered second absorbing means 4b and tapered third energy absorbing means 4c. FIG. 3b schematically illustrates a tapered first energy absorbing means 4a. Such tapered energy absorbing means as illustrated in FIGS. 3a and 3b could for instance be used to cause a more gradual acceleration build up as an energy absorbing means is engaged. Thus, at least one of the first energy absorbing means 4a and the second energy absorbing means 4b at least partly may have a tapered cross sectional area.

The energy absorber 1a, 1b, 1c, 1d, 1e may have a tubular coverage 20. The tubular coverage 20 may enclose the energy absorbing means 4a, 4b, 4c, the coupling mechanism 7, 9, 39, 45 and (at least partly) the bar 8, and provide radial as well as axial support for the energy absorbing means 4a, 4b, 4c. Hence the energy absorber 1a, 1b, 1c, 1d may further comprise a tubular coverage 20 enclosing at least the bar 8, the coupling mechanism 7, 9, 39, 45, the first energy absorbing means 4a, and the second energy absorbing means 4b.

As noted above, the energy absorber 1a, 1b, 1c, 1d, 1e may comprise at least one further energy absorbing means 4c. Particularly, the energy absorber 1a, 1b, 1c, 1d, 1e may comprise a third energy absorbing means 4c. The energy absorber 1a, 1b, 1c, 1d, 1e may further comprise a further coupling mechanism 7, 9, 39, 45 for coupling the third energy absorbing means 4c to the bar 8. The bar 8 and the further coupling mechanism 7, 9, 39, 45 are arranged such that movement of the bar 8 along the longitudinal axis z causes a rotation of the further coupling mechanism 7, 9, 39, 45 about the longitudinal axis z. The further coupling mechanism 7, 9, 39, 45 is arranged to activate energy absorption of the third energy absorbing means 4c by coupling the third energy absorbing means 4c to the bar 8 when the rotation of the further coupling mechanism 7, 9, 39, 45 is faster than a second predetermined non-zero amount larger than the first predetermined non-zero amount. As the skilled person understands the herein disclosed energy absorber 1a, 1b is not limited to comprising only two or three energy absorbing means; the herein disclosed energy absorber 1a, 1b, 1c, 1d, 1e may comprise a plurality of energy absorbing means, each with its own coupling mechanism 7, 9, 39, 45, and where each energy absorbing means is engaged in turn.

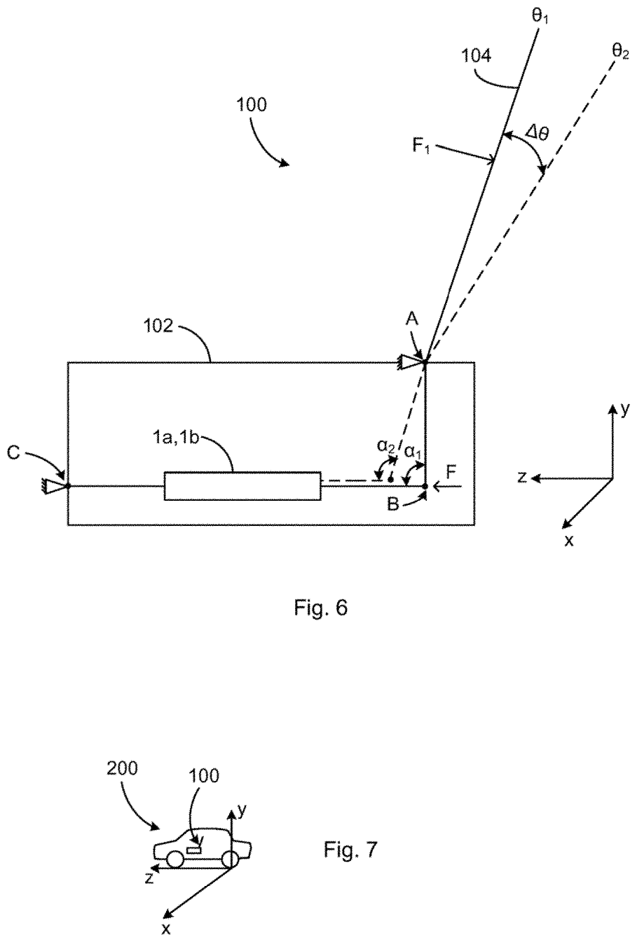

A non-limiting exemplary application where an energy absorber 1a, 1b, 1c, 1d as disclosed above is used in a vehicle seat to mitigate whiplash injuries will now be described. Hence, the herein disclosed energy absorber 1a, 1b, 1c, 1d may be part of a vehicle seat. A mechanically energy absorbing vehicle seat may thus comprise at least one energy absorber 1a, 1b, 1c, 1d as disclosed above. FIG. 6 schematically illustrates a side view of a vehicle seat 100. FIG. 7 schematically illustrates a side view of a vehicle 200 comprising at least one vehicle seat 100.

In more detail, FIG. 6 shows a principled and stylized view of a vehicle seat 100 seen in a longitudinal view (the yz plane). FIG. 7 also shows a coordinate system based on the assembly of the vehicle seat 100 in the vehicle 200. The vehicle seat 100 comprises an energy absorber 1a, 1b arranged in the seat 102 of the vehicle seat 100. The vehicle seat 100 comprises the following principle components: a seat 102 (i.e., the seat load bearing structure), a backrest 104 (i.e., the back load bearing structure); as well as an energy absorber 1a, 1b, 1c, 1d, which is arranged in the seat 102 with the purpose of transferring kinetic energy from an imagined seat occupant (not illustrated), that in use is placed in the vehicle seat 100, to an energy absorber by a linear displacement during mechanical resistance. The energy absorber 1a, 1b, 1c, 1d according to the exemplary scenario comprises three energy absorbing means of Divinycell HCP 100 that are located in a cylindrical tube (defining a tubular coverage of the energy absorber 1a, 1b, 1c, 1d).

In the initial phase of a collision the torso of the seat occupant is pressed against the backrest 104. The force arising between the backrest 104 and the seat occupant can perform mechanical work, if the vehicle seat 100 at this stage is allowed to move in a translating motion, or if the backrest 104 is allowed to rotate, in the presence of resistance. This mechanical work can be transferred and accumulated. For example, the mechanical work may be accumulated in the energy absorber 1a, 1b, 1c, 1d.

If the backrest 104 is allowed to rotate during mechanical resistance, the forces on the head and cervical spine of the seat occupant will be reduced. The backrest 104 is pivotally connected with the seat 102 in point A about an axis parallel to the transverse direction (x direction) of the vehicle seat 100 (and thus also the vehicle 200) as well as with the energy absorber 1a, 1b, 1c, 1d around point B about an axis parallel to the transverse direction of the vehicle seat 100. The energy absorber 1a, 1b, 1c, 1d is in turn pivotally arranged to the seat 102 about a point C about an axis parallel with the transverse direction of the vehicle seat 100.

During collision from the behind the torso of the seat occupant is initially pushed towards the backrest 104. The backrest 104 is allowed to rotate during mechanical resistance from the energy absorbing element at an angle Δθ by the impact of a resultant force F1, which is time dependent. When the backrest 104 thus rotates as a result of the torso of a seat occupant is pressed against the backrest 104 and gives rise to the force F1 towards the same due to the collision, the rotational movement is transformed into a rectilinear movement in the energy absorber 1a, 1b, 1c, 1d, which reduces the forces and accelerations of the head and the cervical spine of the seat occupant.

As the backrest 104 is rotatably disposed in the seat 102 at point A as well as in the energy absorber 1a, 1b at point B at the same time as the energy absorber 1a, 1b is rotatably fixed at point C, the rotational movement of the backrest 104 will be transformed into a rectilinear movement whose distance is dependent on the distance between the rotation points A and B and the angle change Δθ of the backrest 104 from the starting position. The rotation Δθ depends on the mechanical resistance in the energy absorber 1a, 1b, 1c, 1d and the amount of energy transmitted. The energy absorber 1a, 1b, 1c, 1d may be disposed and oriented to maximize the length of the lever arm formed between the points A and B.

An angle a between a straight line through the points A and B and a straight line between points B and C increases (i.e., α2>α1) when the backrest 104 rotates an angle Δθ due to the torso of the seat occupant is pressed against the backrest 104 during collision whilst the energy absorber 1a, 1b, 1c, 1d is compressed.

Thus, as the crushing force of the energy absorber 1a, 1b is exceeded, the energy absorbing means 4a, 4b, 4c in turn deform in a controlled manner, thus allowing the backrest 104 to swivel backwards, in effect lowering the acceleration of the head and torso of the seat occupant. One of the energy absorbing means (such as the first energy absorbing means 4a) may always be engaged. The crushing force of this energy absorbing means determines the acceleration at which the energy absorber 1a, 1b starts to limit the acceleration of the seat occupant. The remaining energy absorbing means are engaged at certain levels of bar velocity (corresponding to the first predetermined non-zero amount and the second predetermined non-zero amount, respectively), thereby step-wise increasing the crushing force (i.e., energy absorption) of the energy absorber 1a, 1b, 1c, 1d. In this respect, the trigger element could be arranged to be displaced for activating the force transferring element for coupling and activation of the second energy absorbing means to the bar when the velocity of the bar is higher than the first pre-determined non-zero amount, at which point of activation an infinitesimal velocity increase results in a step-wise increase of the energy absorption.

By varying the crushing force of the energy absorbing means 4a, 4b, 4c (cross sectional area, type of element material, etc.) and the trigger velocities at which the energy absorbing means 4a, 4b, 4c are engaged, the characteristics of the energy absorber 1a, 1b, 1c, 1d can be varied.

Simulation results from using an energy absorber 1a, 1b, 1c, 1d as disclosed above in a vehicle seat to mitigate whiplash injuries when subjected to whiplash vehicle acceleration curves according to the European New Car Assessment Programme (Euro NCAP) will now be presented.

One purpose of the simulation is to investigate how and to what extent the herein disclosed energy absorber 1a, 1b, 1c, 1d may be used to mitigate acceleration forces the seat occupant is subjected to during a collision. Another purpose of the simulation is to investigate how and to what extent the characteristics of the energy absorber 1a, 1b, 1c, 1d may be varied. This analysis does not take into account what injuries a seat occupant may sustain due to the acceleration profiles used. One object of the analysis is to provide insight into how the herein disclosed energy absorber 1a, 1b, 1c, 1d may be used to shape and alter the acceleration the seat occupant is subjected to.

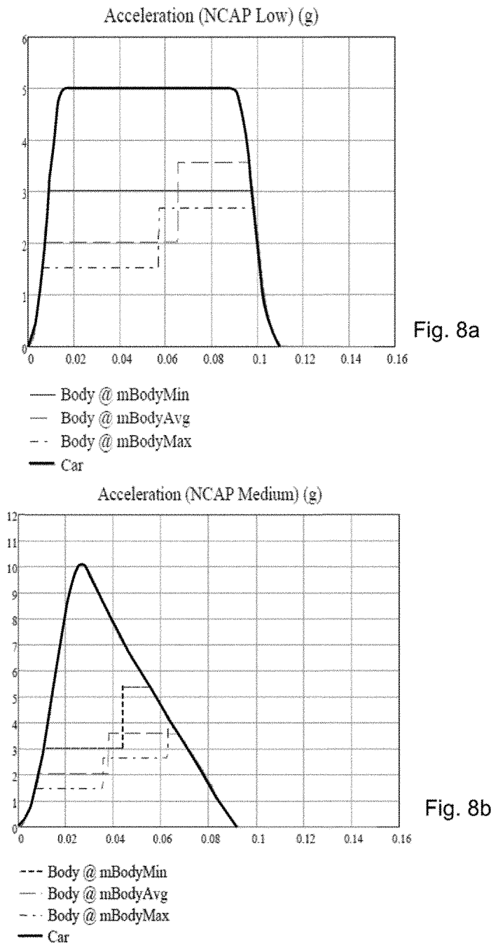

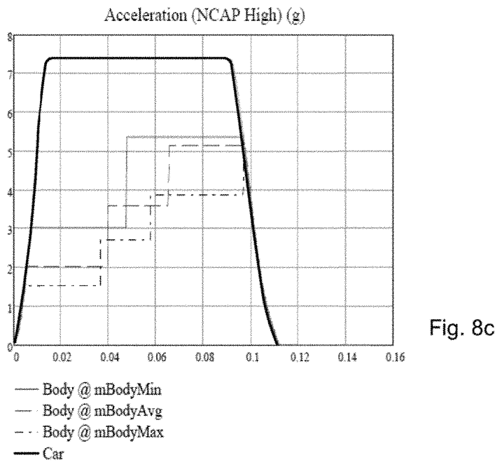

References are now made to FIGS. 8a, 8b, and 8c. For each Euro NCAP curve (Low, Medium and High) the acceleration of each of the body masses (torso and head mass) mBodyMin=27.1 kg, mBodyAvg=40.7 kg, and mBodyMax=54.3 kg have been plotted, as well as the acceleration of the car (the Euro NCAP curve) as a function of time. The car comprises a vehicle seat 100 as disclosed above. It can be seen in FIGS. 8a, 8b, and 8c that the herein disclosed energy absorber 1a, 1b, 1c, 1d greatly limits the acceleration that the seat occupant is subjected to.

Another non-limiting exemplary application where an energy absorber as herein disclosed may be used will now be described. According to this non-limiting example, hereinafter denoted a seventh embodiment, the energy absorber is arranged to enhance the energy absorbing capability of a beam element.

In general terms, beam elements are frequently used as load supporting structures in many different applications. The desire to build lightweight structures may, however, contradict the desire to provide sufficient energy absorbing capability in the beam element. One way of increasing the energy absorbing capability of a beam element is to integrate an energy absorber as herein disclosed in the beam element.

FIG. 10 shows the case where the force F is assumed to be a compressive force, but it is understood that, by reconfiguration, the energy absorber 1e could be adapted for absorbing energy upon a tensile load acting on the beam.

It is also understood that any of the above disclosed six embodiments can be integrated in beam element to enhance the energy absorbing capability.

The invention has mainly been described above with reference to a few embodiments. The present invention may be embodied in many different forms and should not be construed as limited to the applications shown herein. For example, the application of using the herein disclosed energy absorber 1a, 1b, 1c, 1d in a car seat is but one application where the herein disclosed energy absorber 1a, 1b, 1c, 1d may be used and shall not be construed as the only possible application of the herein disclosed energy absorber 1a, 1b, 1c, 1d. It can generally be used in different contexts in which it is desired energy dissipation due to collisions, bumps and the like. Thus, as is readily appreciated by a person skilled in the art, other embodiments than the ones disclosed above are equally possible within the scope of the invention, as defined by the appended patent claims.

1-53. (canceled)

54. An energy absorber comprising:
a bar extending along a longitudinal axis and arranged to be moved along the longitudinal axis upon a tensile force acting on the bar along the longitudinal axis;
a first energy absorbing means and a second energy absorbing means extending along the longitudinal axis; and
a coupling mechanism for coupling the second energy absorbing means to the bar;
wherein the bar is arranged to activate energy absorption of the first energy absorbing means upon movement of the bar along the longitudinal axis;
wherein the coupling mechanism comprises at least one force transferring element arranged to transfer force from the bar to the second energy absorbing means upon activation by at least one trigger element;
wherein the trigger element is arranged to be subjected to a trigger load as the bar is moved along the longitudinal axis, wherein the trigger load is proportional to velocity of the bar such that a higher velocity results in a higher trigger load;
wherein the trigger element is displaceably arranged relative to its unloaded position upon loading and, simultaneously, constrained from displacing by a constraining force acting in opposite direction of the trigger load; and
wherein the trigger element is arranged to be displaced for activating the force transferring element for coupling and activation of the second energy absorbing means to the bar when the velocity of the bar is higher than a first pre-determined non-zero amount, at which point of activation an infinitesimal velocity increase results in a step-wise increase of the energy absorption.

55. The energy absorber according to claim 54, wherein the trigger load is created by a hydraulic or pneumatic pressure.

56. The energy absorber according to claim 54, wherein the trigger load is created by a magnetic field.

57. The energy absorber according to claim 54, wherein the trigger displacement in either radial or axial direction relative to the unloaded position is obtained by translating or rotating the trigger element, wherein, in the case of a radial displacement caused by rotation, the centre of gravity of the trigger element is off-set from the axis of rotation.

58. The energy absorber according to claim 57, wherein the trigger element and the bar are arranged such that movement of the bar along the longitudinal axis causes a first rotation of the trigger element and a centrifugal trigger load acting on the trigger element.

59. The energy absorber according to claim 58, wherein the first rotation, caused by the movement of the bar, is about an axis parallel with, perpendicular—or oblique to the longitudinal axis of the bar, wherein the trigger element is arranged to activate energy absorption of the second energy absorbing means by activating the force transferring element when the rotation of the trigger element is faster than a first pre-determined non-zero amount, and wherein the trigger element is arranged to be radially displaced relative to the first axis upon a second rotation about an axis off-set from the first axis and parallel with, perpendicular to, or oblique to, the first axis.

60. The energy absorber according to claim 54, wherein the constraining force acting in opposite direction of the trigger load is provided by a pin, spring, wire, adhesive, magnet, weld, soldering, friction element, or any combination thereof.

61. The energy absorber according to claim 54, further comprising:
a third energy absorbing means; and
a further coupling mechanism comprising a further trigger element for activating coupling of the third energy absorbing means to the bar through a further force transferring element;
wherein the bar and the further coupling mechanism are arranged such that the movement of the bar along the longitudinal axis causes a rotation of the further trigger element; and
wherein the further trigger element is arranged to activate energy absorption of the third energy absorbing means by activating the further force transferring element coupling the third energy absorbing means to the bar when the rotation of the further trigger element is faster than a second predetermined non-zero amount larger than the first non-zero predetermined non-zero amount.

62. The energy absorber according to claim 54, further comprising piston elements axially connected at one of its end with one end of its associated energy absorbing means, each of which axially fixed at the other end;
wherein the piston elements are arranged to distribute the force from the bar over a specified area of the end of the energy absorbing means; and
wherein the piston element of the first energy absorbing means is axially connected such that the first energy absorbing means is pressurized before the second energy absorbing means as a result of the force acting along the longitudinal axis; and
wherein the piston element of the second energy absorbing means is arranged to pressurize the second energy absorbing means upon activation of the force transferring element trough the trigger element.

63. The energy absorber according to claim 54, wherein the bar is a toothed rack, and wherein the trigger element is arranged to be rotated about an axis perpendicular or oblique to the longitudinal axis upon the force acting on the bar along the bar along the longitudinal axis.

64. The energy absorber according to claim 63, wherein the coupling mechanism comprises a base body arranged with a lengthwise cavity to accommodate both the bar and a load transferring element in the form of a wedge such that the base body, the wedge and the bar constitutes a wedge joint at the point of activation of the second energy absorbing element.

65. The energy absorber according to claim 64, wherein a piston element is arranged on the base body, the piston element axially coupled to the second energy absorbing means.

66. The energy absorber according to claim 64, wherein the wedge element comprises a cavity to accommodate a gear wheel mounted in the wedge; and wherein the rotational axis of the gear wheel is oriented in the perpendicular or oblique axis of the longitudinal axis of the bar.

67. The energy absorber according to claim 66, wherein rotation of the gear wheel causes a first rotation of the trigger element and a centrifugal force acting on the trigger element.

68. The energy absorber according to claims 55, wherein the force transferring elements is a fluid or gas.

69. The energy absorber according to claims 56, wherein the coupling mechanism comprises a magnet in relative motion with a nearby conductive object.

70. The energy absorber according to claim 54, wherein the first energy absorbing means and the second energy absorbing means comprise a solid material, a fluid material, a gaseous material, or any combination thereof.

71. The energy absorber according to claim 54, wherein the material of the first energy absorbing means is different from the material of the second energy absorbing means.

72. A mechanically energy absorbing chair comprising at least one energy absorber according to claim 54.
